(19) United States
(12) Patent Application Publication
(10) Pub. No.: US 2025/0273736 A1
(43) Pub. Date: Aug. 28, 2025

(54) FLEXIBLE BATTERY

(71) Applicant: Anthro Energy, Inc., San Jose, CA (US)

(72) Inventors: Matthew McGuire, San Jose, CA (US); Shane Shearman, San Jose, CA (US); Joseph K. Papp, San Jose, CA (US); David George Mackanic, San Jose, CA (US)

(73) Assignee: Anthro Energy, Inc., San Jose, CA (US)

(21) Appl. No.: 19/205,251

(22) Filed: May 12, 2025

Related U.S. Application Data
(63) Continuation-in-part of application No. 18/960,109, filed on Nov. 26, 2024.
Application No. 18/960,109 is a continuation of application No. 18/443,716, filed on Feb. 16, 2024, now Pat. No. 12,191,447.
(63) Continuation-in-part of application No. 18/779,553, filed on Jul. 22, 2024, now abandoned.
(60) Provisional application No. 63/485,332, filed on Feb. 16, 2023.

(51) Int. Cl. H01M 10/0565; H01M 4/02; H01M 4/62

(52) U.S. Cl. CPC H01M 10/0565; H01M 4/622; H01M 4/625; H01M 2004/027; H01M 2004/028; H01M 2300/0082; H01M 2300/0085

(57) ABSTRACT

A flexible battery can include a cathode current collector; a cathode disposed on the cathode current collector; an anode current collector; an anode disposed on the anode current collector; a separator disposed between the cathode and the anode; an electrolyte interspersed within the cathode, the separator, and the anode; and a casing enclosing the cathode current collector, the cathode, the separator, the anode, and the anode current collector.

### CROSS-REFERENCE TO RELATED APPLICATIONS

This application is a continuation-in-part of U.S. patent application Ser. No. 18/960,109 filed 26 Nov. 2024, which is a continuation of U.S. patent application Ser. No. 18/443,716 filed 16 Feb. 2024 which claims the benefit of U.S. Provisional Application No. 63/485,332 filed 16 Feb. 2023, each of which is incorporated in its entirety by this reference. This application is also a continuation-in-part of U.S. patent application Ser. No. 18/779,553 filed 22 Jul. 2024, which is incorporated in its entirety by this reference.

### TECHNICAL FIELD

This invention relates generally to the battery field, and more specifically to a new and useful battery cell designs in the battery field.

### BRIEF DESCRIPTION OF THE FIGURES

FIG. 1 is a schematic representation of an exemplary battery.

FIG. 2 is a schematic representation of an example of a battery cell (or stack of battery cells) that includes a buried weld.

FIG. 3A is exemplary data showing battery capacity change for an exemplary battery that includes a buried weld over 10,000 flexions.

FIG. 3B is exemplary data showing battery capacity change (e.g., loss) and voltage instability for an analogous battery (e.g., analogous to that of the exemplary battery in FIG. 3A such as same cathode, anode, electrolyte, separator, etc. thickness, loading, composition, total size, etc.), except that does not include a buried weld, over 10,000 flexions.

FIGS. 4A and 4B are schematic representations of an exemplary battery cell (or stack of battery cells) that include folded current collector tabs.

FIG. 5A is exemplary data showing battery capacity change for an exemplary battery that includes a folded current collector tab over 20,000 total flexions (e.g., each flexion period includes about 10,000 flexions).

FIG. 5B is exemplary data showing battery capacity change (e.g., loss) for an analogous battery (e.g., analogous to that of the exemplary battery in FIG. 5A such as same cathode, anode, electrolyte, separator, etc. thickness, loading, composition, total size, etc.), except that does not include a folded current collector tab, over 10,000 flexions.

FIGS. 6A, 6B, and 6C are pictographic representations of exemplary structured battery cells (or stacks thereof), where every component of the stack has the structure (e.g., corrugation, waffle pattern, etc.).

FIG. 7A is exemplary data showing battery capacity change for an exemplary battery that is structured (e.g., corrugated, waffle-pattern, etc.) over 100,000 flexions.

FIG. 7B is exemplary data showing battery capacity change (e.g., loss) for an analogous battery (e.g., analogous to that of the exemplary battery in FIG. 7A such as same cathode, anode, electrolyte, separator, etc. thickness, loading, composition, total size, etc.), except that is not structured, over 10,000 flexions.

FIG. 8 is a pictograph of an exemplary test set-up for electrochemically cycling a battery concurrently with mechanically cycling (e.g., flexion) of the battery.

FIG. 9 is a schematic representation of an example of a cured battery cell.

### DETAILED DESCRIPTION

The following description of the embodiments of the invention is not intended to limit the invention to these embodiments, but rather to enable any person skilled in the art to make and use this invention.

### 1. Overview

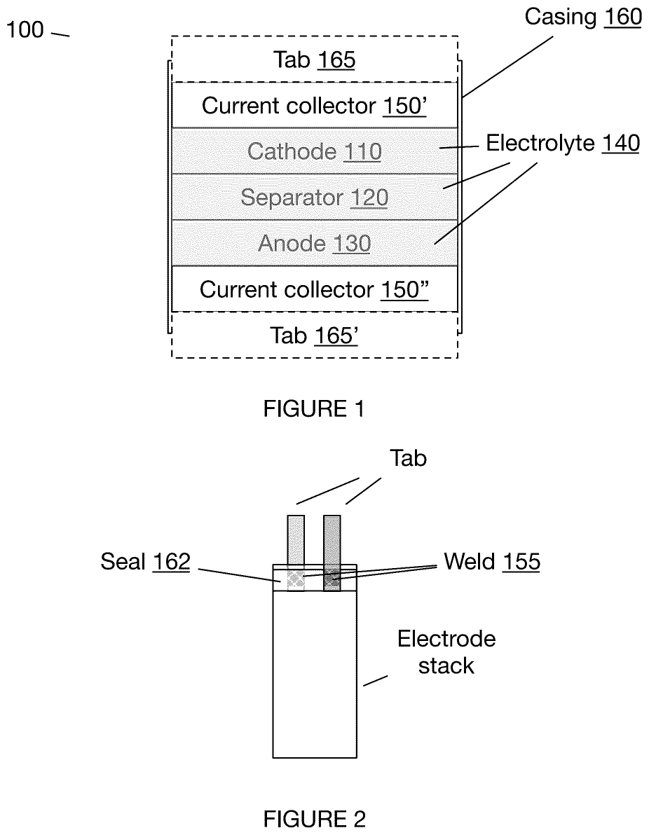

As shown in FIG. 1, a battery can include one or more battery cells, where each battery cell can include a cathode 110, an anode 130, a separator 120, an electrolyte 140, a current collector 150 (e.g., a cathode current collector 150′, an anode current collector 150″), a housing 160 (e.g., casing, enclosure, etc.), a tab 165 165′, and/or any suitable components. The batteries are preferably designed (e.g., expected to experience) mechanical stresses (e.g., from flexing, bending, torsion, shear, compressive stress, tensile stress, fatigue stress, etc.) without significant impact to the battery capacity (e.g., gravimetric or volumetric capacity).

The battery can include a single cell (e.g., single anode/cathode pair) and/or a plurality of cells (e.g., 2 anode/cathode pairs, 3 anode/cathode pairs, 5 anode cathode pairs, 10 anode/cathode pairs, 20 anode/cathode pairs, 50 anode cathode pairs, 100 anode/cathode pairs, 500 anode/cathode pairs, 1000 anode cathode pairs, values or ranges therebetween, etc.). Note that an anode and/or cathode can have a single paired electrode and/or two paired electrodes (for instance, a double-sided anode can be act as the anode for two cathodes).

In typical embodiments, the battery capacity degrades by at most about 10% (e.g., as an absolute percentage, as a relative percentage to the capacity loss during battery cycling) more for a battery than undergoes tens of thousands of flexions compared to the same battery (e.g., substantially identical structurally, materially, size, manufactured in the same manner, using the same material lots, etc.) that does not undergo flexion. As an illustrative example, a battery that does not undergo flexion may experience a capacity decrease to about 90% of an initial capacity after 100-1000 charging and discharging cycles whereas the same battery that undergoes 10,000 to 50,000 flexion cycles can have a capacity decrease to at least 80% (e.g., 80.5%, 82%, 85%, 90%, etc.) of the initial capacity after the same 100-1000 charging and discharging cycles. However, the battery can experience any suitable capacity change as a result of flexion.

Examples of the battery can include one or more of the following to achieve capacity resilience to flexion: gel-polymer electrolytes (e.g., electrolyte solutions that cure to form a gel electrolyte), ‘buried’ welds (e.g., welds that include a seal 162 or other barrier to improve mechanical resilience of the weld 155), compliant current collector tabs 152 (e.g., current collectors designed to include improved mechanical compliance), structured battery cells 168 (e.g., battery cells with structural designs that enable improved bending or flexion), and/or other suitable improvements or battery design considerations.

The batteries as described herein are typically envisioned for applications where the battery can undergo flexion or other mechanical stresses such as integration into an external system frame and/or use of the battery directly as a structural feature. Exemplary systems that can utilize such flexible batteries include (but are not limited to): vehicles (e.g., automobiles, unmanned aerial vehicles, trains, boats, etc.), user electronics (e.g., laptops, tablets, smart phones, cell phones, foldable phones, etc.), wearables (e.g., smart glasses, watches, clothing, rings, jewelry, etc.), power tools, portable gaming systems, medical devices, and/or other suitable systems. These batteries can additionally or alternatively be used in systems that are not expected to undergo flexion (e.g., to provide additional safety in the event of unexpected mechanical stress) and/or other suitable battery systems.

### 2. Technical Advantages

Variants of the technology can confer one or more advantages over conventional technologies.

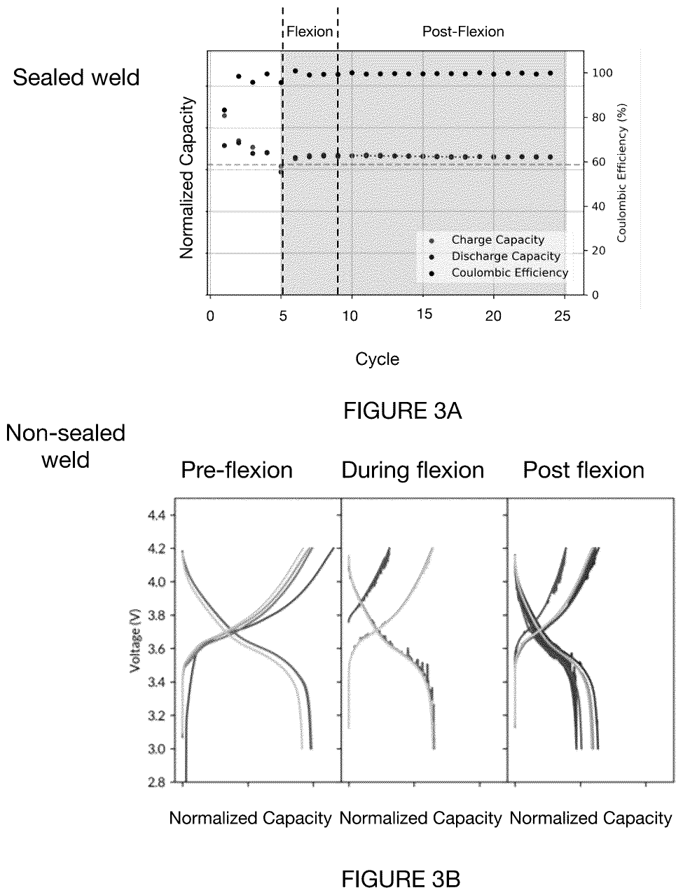

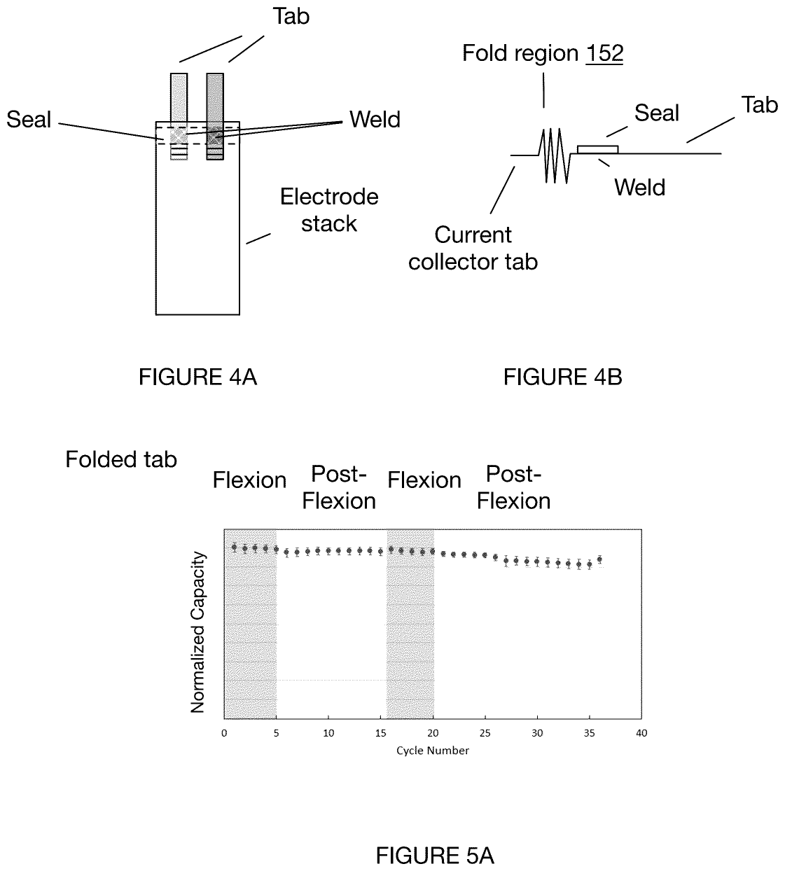

First, the inventors have discovered that one of the primary mechanisms for reduction in capacity of a battery undergoing flexion is failure of a weld within the battery (e.g., between a current collector and a tab). As the battery experiences mechanical stress and deformation, the weld weakens and can eventually breaks resulting in a sudden drop in capacity (as shown for example in FIG. 3B). To overcome this failure mechanism, the inventors have discovered that ‘burying the weld’ (e.g., covering the weld with a sealing material) can protect the weld from cumulative damage thereby avoiding the reduction in capacity from weld degradation (as shown for example in FIG. 3A).

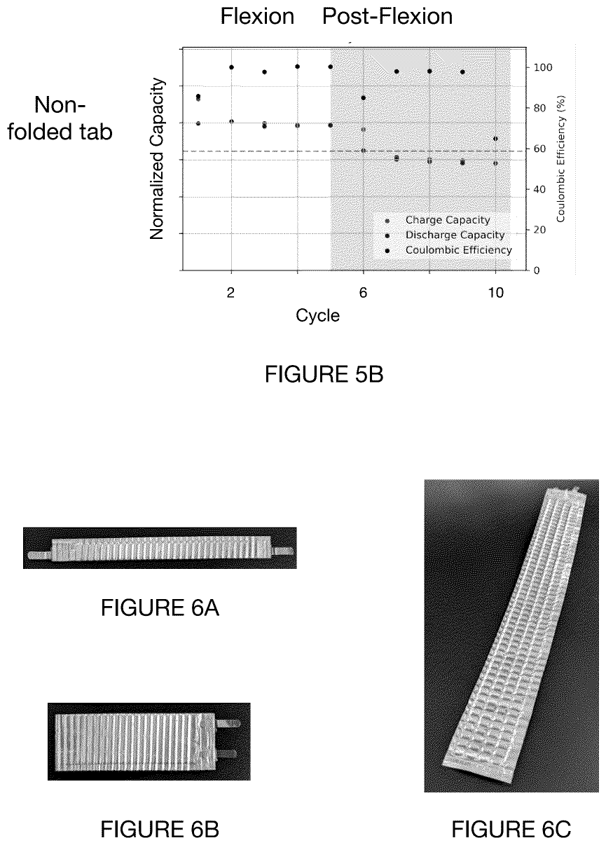

Second, the inventors have discovered that another of the primary mechanisms for reduction in capacity of a battery undergoing flexion is mechanical failure (e.g., ripping, tearing, etc.) of a tab (e.g., current collector tab also just referred to as current collector herein) of the battery. As the battery experiences mechanical stress and deformation, the mechanically unsupported or weak portions of the battery such as the current collector (e.g., exposed portions of the current collector, portions of the current collector that do not have electrochemically active materials deposited on them, etc.) can break (e.g., tear) during flexion resulting in internal disconnection of the battery (as shown for example in FIG. 5B). The inventors have found that this failure mode can occur in up to about 50% of batteries (e.g., without improvements as described herein) after 10000 flexion cycles. To overcome this failure mechanism, the inventors have discovered that increasing the size of the region (e.g., doubling the length compared to typical current collector tabs) and/or providing increasing compliance of these regions (e.g., folding, using fibers, etc.) can protect mechanically weak regions cumulative damage thereby avoiding the reduction in capacity from current collector tearing (as shown for example in FIG. 5A).

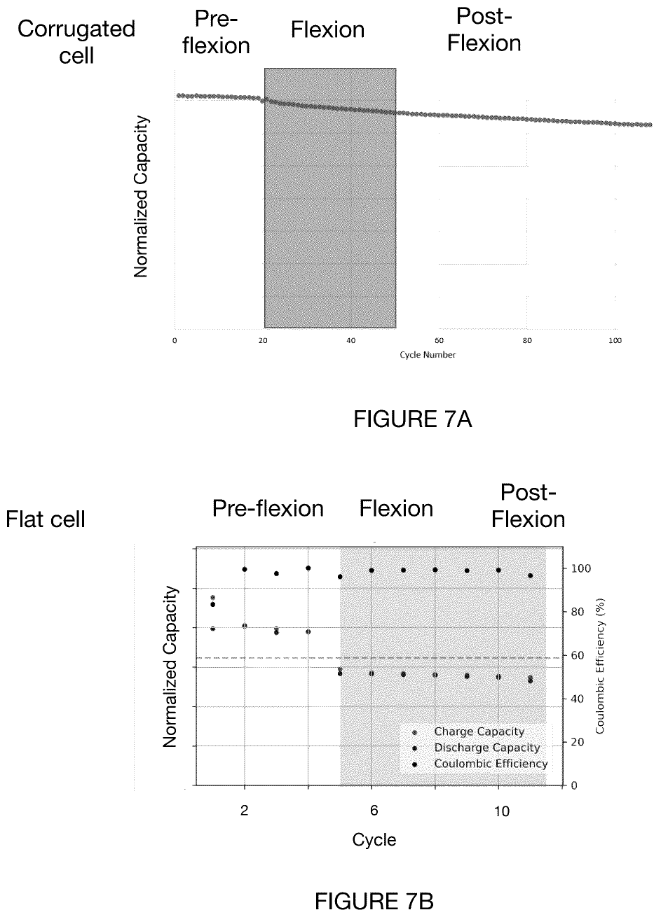

Third, the inventors have discovered that another of the primary mechanisms for reduction in capacity of a battery undergoing flexion is mechanical failure (e.g., cracking, separating, delaminating, ripping, tearing, etc.) of an electrode (e.g., anode, cathode) and/or separator of the battery. As the battery experiences mechanical stress and deformation, the electrodes and/or separators of the battery can break (e.g., crack) during flexion resulting in internal disconnection of the battery (as shown for example in FIG. 7B). To overcome this failure mechanism, the inventors have discovered that increasing the patterning the battery cell (e.g., corrugation, waffle pattern, etc.) can provide regions of bending inherent to the battery structure thereby avoiding the reduction in capacity from electrode and/or separator cracking (as shown for example in FIG. 7A).

The above solutions can be used in isolation (e.g., for a battery where the primary degradation mechanism is electrode cracking, structured battery cells could be used without burying the weld or structuring the current collector tab) and/or in any suitable combination. Each of these solutions can result in a modest decrease in the total gravimetric (e.g., because of additional mass of material) and/or volumetric (e.g., because of space consideration) energy density; however, these modest impacts are typically less than about 5% of the gravimetric or volumetric battery capacity whereas the failure modes would result in losses on the order of 50% or more the gravimetric or volumetric battery capacity.

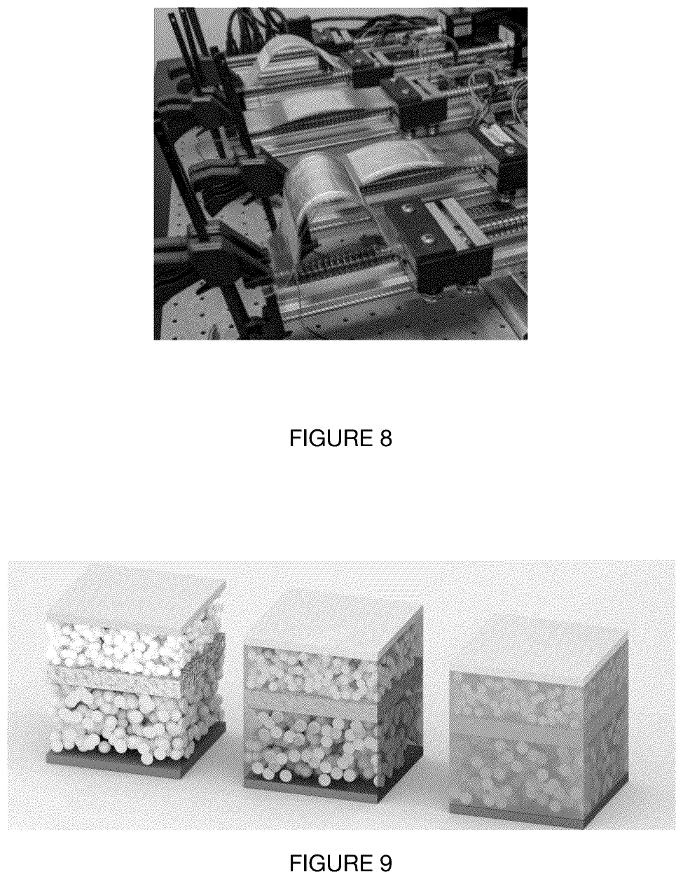

In these specific examples, the data can be measured using a flexion cycling tool (as shown for example in FIG. 8 such as using 2 fixed ends, a linear rail,) where flexion can be cycled concurrently with electrochemical cycling. Typically, the cell is flexed at a high rate than electrochemical cycling. However, the cell can be flex at a lower rate or the same rate as the cell is electrochemically cycled. The flexion cycling rate is typically greater than about 1 s/flex (e.g., 5 s/flex, 7 s/flex, 10 s/flex, 15 s/flex, 20 s/flex, 50 s/flex, 100 s/flex, 1000 s/flex, etc.). However, the flexion cycling rate can be less than about 1 s/flex. The cell is typically flexed to a bend radius between about 1 mm and 1 m. However, a cell can be flexed to any suitable bend radius (e.g., based on a target application of the cell, anticipated forces or bends experienced by the cell, etc.). However, the battery cells can otherwise be tested.

However, further advantages can be provided by the system and method disclosed herein.

### 3. Battery

As shown in FIG. 1, a battery can include one or more battery cells, where each battery cell can include a cathode, an anode, a separator, an electrolyte, a current collector (e.g., a cathode current collector, an anode current collector), a housing (e.g., casing, enclosure, etc.), a tab, and/or any suitable components. The batteries are preferably designed (e.g., expected to experience) mechanical stresses (e.g., from flexing, bending, torsion, shear, compressive stress, tensile stress, fatigue stress, etc.) without significant impact to the battery capacity (e.g., gravimetric or volumetric capacity).

These batteries are often pouch cells (e.g., utilize a sealed pouch to contain the battery components such as wound pouch cells, stacked pouch cells, z-folded pouch cells, etc.). Alternatively phrased, a casing (e.g., enclosure, housing, etc.) of the battery typically has a pouch format. However, these batteries can additionally or alternatively be cylindrical cells, prismatic cells, cells of unusual form factors, and/or other suitable battery cells and/or have other suitable casing. The casing can be made of metal (e.g., steel, stainless steel, etc.), ceramics, plastic, wood, glass, and/or any suitable materials.

In some variants, the casing can be tapered (e.g., be thinner at one end than another). For instance, the casing can taper such that the casing is thinner on an end where tabs protrude from the battery. In another example, the casing can be thinner proximal a sealing region of the casing. These variants can be beneficial as they can result in improved feel of the battery and/or can increase flexibility of the battery cell.

The casing is preferably sealed (e.g., hermetically sealed to hinder or prevent ingress of materials from the environment into the battery (which can result in battery degradation, fire, etc.). For instance, the casing can be hermetically sealed using a polymeric sealant (e.g., polyurethane, acrylics, butyl polymers, silicone polymers, polysulfides, silicon-curable polyurethane, silicon-curable polyether, silicon-curable polyisobutylene, silicon-curable acrylics, etc. such as thermoplastic, thermosetting, etc. polymers). In some variations, a cured polymer electrolyte (such as described below) can be used to form the seal. However, the casing can otherwise be sealed (e.g., using gaskets, metal-metal joints, etc.).

Typically, the seal is several mm thick to ensure isolation of the battery internals relative to the external environment. However, this can result in decreased flexibility (e.g., increased stiffness) of the battery. In some variants, the inventors have found that they can have the seal extend outside the casing (e.g., forming beads of sealant), which can result in both improved environmental isolation and increased flexibility of the battery. In such variants, the sealant region (e.g., length of sealant within the casing) can be reduced to about 1 mm (e.g., 0.5 to 3 mm).

In variants that include a tab, the tab functions to shuttle electricity (e.g., electrons) out of the battery and into an external system (i.e., functions to interface the battery with an external system, battery pack, battery module, etc.). The tab is typically welded to the current collector (e.g., the current collector tab). However, the tab can otherwise be bonded to the current collector (e.g., adhered using an electrically conductive adhesive).

The tab weld is preferably entirely enclosed within a seal (e.g., the same seal as the casing is sealed with, a different sealing material from the casing, etc.). Any region of the tab extending beyond the weld (e.g., proximal the electrodes along the current collector) is preferably also enclosed within the seal. For example, the casing sealing region can be doubled such that it covers both the weld and outside (or inside) the weld on only the casing to ensure both the weld is enclosed in the seal and that the casing is sealed. In some variations, rather than enclosing the tab in a seal, the tab can be enclosed in a non-sealing (or non-hermetically sealing) material such as a hard plastic (e.g., polymethylmethacrylate, polycarbonate, polyvinyl chloride, acrylonitrile butadiene styrene, polyoxymethylene, etc.) or other mechanical blocking piece that fully covers the weld (e.g., both sides of the weld) and increases a mechanical robustness of the weld. Additional or alternative approaches to improve the mechanical stability of the weld can include increasing a spatial extent of the weld, leveraging a plurality of bonding mechanism (e.g., combining a weld with adhesives), and/or other similar approaches.

In variants that leverage tabless casing designs (e.g., where the external system, battery pack, battery module, etc. are directly connected, welded, bonded, etc. to the current collector tab), the connection between the current collector and the opposing system can be reinforced in a similar manner as the approaches described for improving the tab-current collector tab weld (e.g., ‘burying the weld’ such as enclosing the weld within a seal, leveraging multiple bonding approaches, etc.).

The current collector preferably functions as a support for an electrode and conducts electrons into and out of the electrode. For instance, a cathode current collector can support a cathode and an anode current collector can support an anode. The cathode current collector and anode current collector can be the same or different. The current collectors can be foil, foam, mesh, carbon coated, wire, plate, woven, and/or be any type of current collector. The current collectors are typically made from aluminium (particularly common for the cathode), copper (particularly common for the anode), nickel, titanium, and/or stainless steel. However, the current collectors can be made of any material (e.g., carbonaceous materials such as carbon nanotubes, graphite, graphene, etc.; brass; conductive polymers such as PPy, PANi, polythiophene, etc.; etc.).

In some variants, a woven (or other mesh or porous) current collector can be used. These variants can be particularly beneficial as current collectors of these forms can have greater flexibility (compared to foil current collectors). As a specific example, a current collector can be formed from metal wires (e.g., nickel wires), where each wire is individually coated with a polymer (e.g., polyamide-imide) and where the wires are woven together to form a fabric. In some variations, rather than using the woven fiber for the entire current collector, a woven fabric can be used as current collector tab (where the woven fabric current collector tab can be welded to the current collector such as a foil current collector).

In some variants, the current collectors can include a region that is not coated with active material (e.g., cathode and/or anode materials). This region is often referred to as a current collector tab and can provide a site for connecting the internals of the battery to an external system (e.g., can stick out of the battery casing). However, the current collector can be welded to and/or otherwise connected with a current collector tab.

In preferred variants, the current collector tab is configured to be resilient to mechanical stresses endured by the battery. For instance, the current collector tab can be folded, bent, twisted, reinforced (e.g., thicker than the rest of the current collector), and/or otherwise can be treated to improve a resilience of the current collector tab. As an illustrative example, the current collector tab can include an accordion fold (as shown for example in FIGS. 5A and 5B), half-fold, tri-fold, z-fold, inside quarter fold, quarter fold, quarter pocket fold, half-tri fold, half-z fold, and/or other suitable folds (e.g., a fold can be repeated a plurality of times to achieve additional ridges and/or valleys). In a second example, the current collector tab can be made of a plurality of discrete portions (e.g., ribbons, fibers, etc.). In the second example, the inclusion of a plurality of tabs can result in greater weakness of individual segments, but can enable the electrical contact to remain as there are additional electrical pathway in the event a subset of the portions (e.g., pathways) break. In a third specific example, the current collector tab can be reinforced relative to the rest of the current collector. For instance, the current collector tab can be twice as thick (e.g., 200 μm rather than 100 μm thick as an illustrative example), three times thicker, four times thicker, fives times thicker, and/or other suitable multiple number of times thicker than the rest of the current collector and/or the current collector tab can include a different (e.g., more mechanically resilient) material (e.g., alloy) than the rest of the current collector. Any or all of the preceding examples can be used in combination or isolation.

In variants that combine a reinforced (e.g., buried) weld with increased mechanical resilience in the current collector tab, the increased mechanical resilience portion of the current collector tab is preferably closer to the rest of the battery components (e.g., electrodes) than the weld. However, the weld can be closer to the electrodes than the mechanically reinforced portion of the current collector tab and/or the mechanically reinforced portion of the current collector tab can be coincident with the weld.

To accommodate a mechanically resilient region, the current collector tab is typically longer than a traditional current collector tab. For instance, the current collector tab can be about twice as long as (or greater) a traditional current collector tab (e.g., rather than being 0.5-1 cm current collector tab length, the current collector tab length can be 1-2 cm). Additionally, or alternatively, the current collector tab can have a fixed additional size (e.g., 0.1 mm, 0.2 mm, 0.25 mm, 0.5 mm, 1 mm, 1.5 mm, 2 mm, 3 mm, 5 mm, 10 mm, values or ranges therebetween, etc.) to accommodate the resilient region.

The cathode (e.g., material thereof) functions to undergo reduction during discharge (e.g., electrons enter the cathode during discharge and leave the cathode during charging). The cathode can include binders (e.g., to bind the cathode active material together, to bind the cathode active material to the current collector, etc.), cathode active material (e.g., the material that participates electrochemically), conductive material (e.g., to increase an electrical conductivity within the cathode active material, to improve shuttling of electrons between the current collector and the cathode active material, etc.), and/or can include any suitable material(s). The cathode active material is preferably a lithium-containing active material (e.g., lithium nickel cobalt manganese oxide (NMC,

NCM) such as NMC 622, NMC 811, NMC532, NMC111, etc.; lithium iron phosphate (LFP); lithium manganese iron phosphate (LMFP); lithium nickel manganese spinel (LNMO); lithium nickel cobalt aluminium oxide (NCA); lithium manganese oxide (LMO); lithium cobalt oxide (LCO); lithium titanate (LTO); lithium transition metal borates such as borophosphates (BPO), borosilicates (BSiO), borosulfates (BSO), etc.; lithium vanadium phosphate (LVP); etc.). However, the cathode active material can additionally or alternatively include sodium-containing active material (e.g., sodium ion battery), potassium-containing cathode active material (e.g., potassium ion battery), magnesium-containing cathode active material (e.g., magnesium ion battery), calcium-containing cathode active material (e.g., calcium ion battery), zinc-containing cathode active material (e.g., zinc ion battery), aluminium-containing cathode active material (e.g., aluminium ion battery), and/or any suitable cathode active material can be used. The cathode active material is typically particulate (e.g., nanoparticle, mesoparticles, macroparticle, etc.), but can form thin films and/or any morphology. Examples of binders include: polyvinylidene fluoride (PVDF), styrene butadiene copolymer (SBR), carboxymethyl cellulose (CMC), polyacrylic acid (PAA), poly (vinyl alcohol) (PVA), humics, poly(3,4-ethylenedioxythio-phene)-polystyrenesulfonate (PEDOT:PSS), chitosan, alginate, combinations or blends thereof, and or other suitable binder(s). Examples of conductive additives include: carbon black, carbon nanotubes, graphite, graphene, fullerenes, carbon fiber (VGCF), Super P Li, S-O, KS-6, KS-15, SFG-6, SFG-15, 350G, acetylene black, Kezin black, and/or any suitable conductive additive or combination of conductive additives can be used.

The anode (e.g., material thereof) functions to undergo oxidation during battery discharge (e.g., electrons leave the anode during discharge and enter the anode during charging). The anode can include binders (e.g., to bind the anode active material together, to bind the anode active material to the current collector, etc. analogous to a binder as described above for a cathode), anode active material (e.g., the material that participates electrochemically), conductive material (e.g., to increase an electrical conductivity within the anode active material, to improve shuttling of electrons between the current collector and the anode active material, etc. analogous to a conductive additive as described above for a cathode), and/or can include any suitable material(s). The anode active material can be carbon based (e.g., graphite, graphitic carbon, carbon fibers, carbon nanotubes, carbon spheres, carbon nanorods, etc.), alloy materials (e.g., aluminium, tin, magnesium, silver, antimony, their alloys, etc.) conversion-type materials (CTAM such as transition-metal sulfides, oxides, hydroxides, phosphides, nitrides, carbides, fluorides, selenides, chalcogenides, oxalates, niobates, etc.), silicon materials, combinations thereof (e.g., mixtures of graphite and silicon), lithium metal, and/or any suitable anode active material. The anode active material is typically particulate (e.g., nanoparticle, mesoparticles, macroparticle, etc.), but can form thin films and/or any morphology. In some variants, the battery does not include an anode.

The separator functions to electrically isolate the anode from the cathode (e.g., prevent electrical short circuiting) while allowing ions (e.g., Li⁺) to pass between the cathode and the anode. The separator can also function to improve the safety of the battery (e.g., by closing pores above a threshold temperature thereby shutting off ion transport) and/or can otherwise function. The separator can be porous, fibrous (e.g., a web, sheet, mat, etc. or oriented or random fibers), and/or have any suitable structure. The porosity of the separator is typically between about 30-50%. However, the porosity can be lower than 30% or higher than 50%. The separator can be made of polymers (e.g., polyolefin such as polyethylene, polypropylene, polybutene, polymethylpentene, etc.; poly(tetrafluoroethylene); poly(vinyl chloride); etc.), nonwoven fibers (e.g., cotton, nylon, glass, polyester, etc.), natural substances (e.g., wood, rubber, asbestos, etc.), and/or of any suitable material.

The electrolyte functions to transport ions between the cathode and the anode (e.g., through the separator). Additional functionalities can be conferred to the electrolyte (e.g., solid-electrolyte interface (SEI) formation, flame retardant, flame suppression, overcharge protection, H₂O and/or HF concentration control, retaining ro holding a structure of the battery, etc.). After curing, the electrolyte is preferably a gel electrolyte (e.g., a solvent, additives, etc. contained within a polymer matrix). However (after curing, in the absence of curing, during curing, during addition to the battery, etc.), the electrolyte can be a solid (e.g., polymeric solid), liquid, and/or can be any suitable state. The electrolyte preferably forms a unified gel electrolyte dispersed throughout the separator and electrodes (as shown for instance in FIG. 9). However, the gel electrolyte can be in contact with (but not distributed throughout, only contact a surface or broad face of, etc.) one or more of the electrodes and/or separators (e.g., in some instances, a gel electrolyte lacking salt can replace or act as a second separator).

The electrolyte can include one or more polymer(s) (and/or polymer precursors such as monomers or oligomers or other formulation components as described below which can be cured or otherwise treated to form a polymer), one or more solvent(s) (e.g., ethylene carbonate (EC), diethyl carbonate (DEC), dimethyl carbonate (DMC), ethyl methyl carbonate (EMC), propylene carbonate (PC), vinylene carbonate (VC), dimethoxyethane (DME), diethyl ether, tetrahydrofuran (THF), methyl formate (MF), ethyl formate (EF), methyl propionate (MP), methyl butanoate, ethyl formate (EF), ethyl acetate (EA), ethyl propionate (EP), ethyl butanoate, propyl formate, propyl acetate (PA), propyl propionate (PP), propyl butanoate, glyme, diglyme, triglyme, tetraglyme, etc.), one or more salt(s) (e.g., lithium hexafluorophosphate (LiPF₆), lithium hexafluoroarsenate (LiAsF₆), lithium tetrafluoroborate (LiBF₄), lithium perchlorate (LiClO₄), lithium tetracyanoborate (LiB(CN)₄) lithium bis(fluorosulfonyl)imide (LiFSI), lithium bis(trifluorosulfonyl)imide (LiTFSI), lithium tris(trifluoromethanesulfonyl)methide (LiTFSM), lithium bis(oxalate)borate (LiBOB), lithium difluoro(oxalato)borate LiDFOB, lithium fluoroalkylphoshpates (LFAP such as lithium tris(pentafluoroethyl)trifluorophosphate), lithium-cyclo-difluoromethane-1,1-bis(sulfonyl)imide (LiDMSI), lithium-cyclo-hexafluoropropane-1,1-bis(sulfonyl)imide (LiHPSI), lithium-cyclo-hexafluoropropane-1,1-bis(sulfonyl)imide (LiBETI), lithium difluoro(oxalato)borate (LiDFOB), lithium bis(monofluoromalonato)borate (LiBFMB), lithium 4,5-dicyano-1,2,3-triazolate (LiDCTA), lithium 2-trifluoromethyl-4,5-dicyanoimidazole (LiTDI), lithium 4,5-dicyano-2-(pentafluorylethyl) imidazole (LiPDI), etc.), one or more additive(s) (e.g., fluoroethylene carbonate (FEC), trivinylcyclotriboroxane (tVCBO), VC, LiDFOB, LiBOB, 1,3,2-dioxathiolane-2,2-dioxide (DTD), vinyl acetate (VA), 2-vinyl pyridine (VP), sulfone, ethyl methyl sulfone, tetramethyl sulfone (TMS), prop-1-ene-1,3-sulfone (PES), 1,3-propane sultone (PS), cyclic sulfate, dioxolone, 5-methyl-4-((trifluoromethoxy)methyl)-1,3-dioxol-2-one, phenyl boronic acid glycol ester (PBE), 5-methyl-4-((trimethylsilyloxy)methyl)-1,3-dioxol-2-one, trimethylphosphate (TMP), triethylphosphate (TEP), tributylphosphate (TBP), triphenylphosphate (TPP), tris(2,2,2-trifluoroethyl)phosphate (TFP), methyl P,P-bis(2,2,2-trifluoroethyl)phosphate (BMP), trimethylphosphite (TMPi), tris (2,2,2-trifluoroethyl)phosphite (TTFPi), dimethyl methyl phosphate (DMMP), diethyl ethylphosphate (DEEP), bis(2,2,2-trifluoroethyl) methylphosphate (TFMP), bis(2,2,2-trifluoroethyl) ethylphosphate (TFEP), hexa(methoxy)cyclotriphosphazene (HMOCPN), (ethoxy)pentafluorocyclotriphosphazene (PFPN), (phenoxy)pentafluorocyclotriphosphazene (FPPN), phoslyte™, etc.), and/or any suitable material(s).

The electrolyte is typically at most about 45% polymer (e.g., weight percent, volume percent, stoichiometric percent, etc. such as 1%, 2%, 5%, 10%, 15%, 20%, 25%, 30%, 40%, etc.), with the remainder being plasticizers (e.g., solvent(s) typically up to about 80%, salt(s) typically up to about 20%, additive(s) typically up to about 10%, where the total percent composition adds up to 100% across all components). However, in some variants, the electrolyte can be solventless (e.g., majority polymer with additives, salts, etc. in the polymer), i.e., up to 90% (by weight, by volume, by stoichiometry, etc.) polymer (with the remaining 10% include salt, additives, etc.). As a specific example, an electrolyte (before curing, treating, polymerization, etc.) can include about 1-10 wt % oligomer, 1-10 wt % monomer, and 80-98 wt % other electrolyte components (e.g., solvent, salt, additives, etc.). In a second specific example, an electrolyte (before curing, treating, polymerization, etc.) can include about 30-40 wt % oligomer, 30-40 wt % monomer, and 20-40 wt % other electrolyte components (e.g., solvent, salt, additives, etc.).

The polymer electrolyte formulation (also referred to as the polymer precursor, prepolymerized solution, formulation, etc.) can include one or more oligomers, one or more monomers, one or more radical inhibitors, one or more radical initiators (typically added immediately before the polymer electrolyte formulation will be cured or treated to form the polymer), one or more additive (e.g., in addition to or alternative to an additive being included in the liquid portion of the electrolyte), liquid electrolyte (e.g., solvent, additives, salts, etc. such as described above) and/or any suitable components.

The oligomers preferably function to form a polymer matrix that enables ionic transport throughout the polymer. The oligomers are preferably difunctional oligomers (e.g., feature polymerizable groups on two sites) which can facilitate and/or enable the formation of a crosslinked polymer network (upon polymerization). The oligomer is typically a co-oligomer (e.g., made from two or more monomers) but could be a homooligomer. The co-oligomer can be an alternative co-oligomer (e.g., A-B-A-B-A-B for monomers A and B), random co-oligomer, block co-oligomer (e.g., A-A-A-A-B-B-B-B for monomers A and B), graft co-oligomer, and/or can have any suitable structure.

The oligomers preferably have non-polar backbone (e.g., hydrocarbon, aliphatic, etc. such as diethylene, triethylene, tetraethylene, pentaethylene, hexaethylene, heptaethylene, octaethylene, nonaethylene, decaethylene, etc.) linked by polar groups (e.g., ester, carbonate, carbamate, carbamide, ether, siloxane, imide, imine, nitrile, etc.).

The oligomer is preferably terminated with an acrylate and/or methacrylate group (to facilitate polymer formation). However, the oligomer can additionally or alternatively be terminated with any suitable end group (e.g., cyanoacrylates, epoxy, imide, thiol, etc.). In a preferred variant, the oligomer can include a functional group that forms dynamic bonds (e.g., hydrogen bond donors and/or acceptors, ionic chelating domains, ion-pairing interactions, metal-ligand interactions, etc. such as carbamide, carbamate, thiocarbamate, imine, boronic esters, etc.) between the end group and the co-oligomer (e.g., a semi-terminal endgroup), which can act as toughening domains and/or ionically conductive domains. Alternatively phrased, an endgroup can be a dynamic bond forming acrylate and/or methacrylate (e.g., carbamide acrylate, carbamate acrylate, thiocarbamate acrylate, imine acrylate, boronic esters acrylate, carbamide methacrylate, carbamate methacrylate, thiocarbamate methacrylate, imine methacrylate, boronic esters methacrylate, etc.). However, the oligomer can include any suitable structure.

For example, polyester urethane acrylates, polyester urethane methacrylates, polyether urethane acrylates, polycarbonate urethane acrylates, polycarbonate-polyether urethane acrylates, polycarbonate-polyester urethane acrylates, polyether-polyester urethane acrylates, polyimide urethane acrylates, polyester acrylates, epoxy acrylates, polycarbonate acrylates, polyester-polycarbonate acrylates, polyether acrylates, polyether-polyester acrylates, polyether-polycarbonate acrylates, polyether-polyester-polycarbonate (or other orderings thereof such as polyether-polycarbonate-polyester, polyester-polyether-polycarbonate, etc.) acrylates, aminated acrylates (e.g., aminated polyether acrylates, aminated urethane acrylates, aminated polyester urethane acrylates, aminated polycarbonate acrylates, combinations thereof, etc.), polycarbonate urethane methacrylates, polycarbonate-polyether urethane methacrylates, polycarbonate-polyester urethane methacrylates, polyether-polyester urethane methacrylates, polyimide urethane methacrylates, polyester methacrylates, epoxy methacrylates, polycarbonate methacrylates, polyester-polycarbonate methacrylates, polyether methacrylates, polyether-polyester methacrylates, polyether-polycarbonate methacrylates, polyether-polyester-polycarbonate (or other orderings thereof such as polyether-polycarbonate-polyester, polyester-polyether-polycarbonate, etc.) methacrylates, aminated methacrylates (e.g., aminated polyether methacrylates, aminated urethane methacrylates, aminated polyester methacrylates, aminated polycarbonate methacrylates, combinations thereof, etc.), polybutadiene urethane acrylates, polybutadiene urethane methacrylates, bisphenol A epoxy diacrylate, silicone urethane acrylate, thioether dendritic acrylates, thioether dendritic methacrylates, functional aliphatic polyether urethane acrylate, difunctional (e.g., diacrylate, diurethane, diurethane diacrylate) aromatic urethane acrylate, hydrophobic urethane acrylates (e.g., difunctional aliphatic hydrophobic urethane acrylate, aliphatic hydrophobic urethane acrylates, etc.), hydrophobic urethane acrylates (e.g., difunctional aliphatic hydrophobic urethane methacrylate, aliphatic hydrophobic urethane methacrylates, etc.), isobornyl acrylate (IBOA), poly(ethylene glycol) methacrylate, poly(ethylene glycol) methyl ether methacrylate, poly(ethylene glycol) diacrylate, trimethylolpropane triacrylate (TMPTA), tripropylene glycol diacrylate (TPGDA), 1,6-hexanediol diacrylate (HDDA), (hydroxyethyl)methacrylate (HEMA), urethane epoxy monomers and/or oligomers (e.g., monofunctionalized with an epoxy head group, difunctionalized with epoxy head groups, etc.), urea epoxy monomers and/or oligomers (e.g., monofunctionalized with an epoxy head group, difunctionalized with epoxy head groups, etc.), urethane imide monomers and/or oligomers (e.g., monofunctionalized with an imide head group, difunctionalized with imide head groups, etc.), urea imide monomers and/or oligomers (e.g., monofunctionalized with an imide head group, difunctionalized with imide head groups, etc.), thiol urethane monomers and/or oligomers (e.g., monofunctionalized with a thiol head group, difunctionalized with thiol head groups, etc.), thiol urea monomers and/or oligomers ((e.g., monofunctionalized with a thiol head group, difunctionalized with thiol head groups, etc.), polycarbonate epoxy oligomers, polyester epoxy oligomers, polyether epoxy oligomers, polycarbonate-polyester epoxy oligomers, polycarbonate-polyether epoxy oligomers, polyester-polyether epoxy oligomers, polycarbonate-polyether-polyester (or other similar variations of ordering) epoxy oligomers, polycarbonate imide oligomers, polyester imide oligomers, polyether imide oligomers, polycarbonate-polyester imide oligomers, polycarbonate-polyether imide oligomers, polyester-polyether imide oligomers, polycarbonate-polyether-polyester (or other similar variations of ordering) imide oligomers, polycarbonate thiol oligomers, polyester thiol oligomers, polyether thiol oligomers, polycarbonate-polyester thiol oligomers, polycarbonate-polyether thiol oligomers, polyester-polyether thiol oligomers, polycarbonate-polyether-polyester (or other similar variations of ordering) thiol oligomers, and many more possible additional carbonates, esters, ethers, nitriles and/or other species. Examples of the above that include more than one polymeric or oligomeric subgroup (polyester-polycarbonate as an illustrative example but true for any of the above similarly reference materials) can form block co-oligomers (also referred to as co-polymers), alternative co-oligomers, random co-oligomers, graft co-oligomers, and/or combinations thereof.

The monomers can function to improve a viscosity (e.g., lower viscosity), wettability (e.g., increase wettability), stability (e.g., increase a lifetime), cycling performance (e.g., SEI formation, SEI stability, SEI ductility, etc.), and/or otherwise can be included in the polymer precursor formulation. Examples of monomers that can be included are: isobornyl acrylate (IBOA), trimethylolpropane triacrylate (TMPTA), tripropylene glycol diacrylate (TPGDA), 1,6-hexanediol diacrylate (HDDA), (hydroxyethyl)methacrylate (HEMA), and/or other suitable acrylates or methacrylates (e.g., acrylic acid, methyl acrylate, ethyl acrylate, 2-chloroethyl vinyl ether acrylate, 2-ethylhexyl acrylate, iso-butyl acrylate, tert-butyl acrylate, iso-decyl acrylate, behenyl acrylate, ethyldiglycol acrylate, heptadecyl acrylate, 4-hydroxybutyl acrylate, hydroxyethylcaprolactone acrylate, lauryl acrylate, 2-propylheptyl acrylate, stearyl acrylate, hydroxylethyl acrylate, phenylacrylate, trimethylolpropane triacrylate, hexanedioldiacrylate, pentaerythritol tetraacrylate, ethyl cyanoacrylate, methyl cyanoacrylate, butyl cyanoacrylate, propylcyanoacrylate, 3-3-dimethylbutyl cyanoacrylate, 2-ethylbutyl cyanoacrylate, 2-ethylhexyl cyanoacrylate, 1-heptyl cyanoacrylate, 2-heptyl cyanoacrylate, 3-heptyl cyanoacrylate, 3-methylbutyl cyanoacrylate, 4-methylpentyl cyanoacrylate, neopentyl cyanoacrylate, octyl cyanoacrylate, 1-pentyl cyanoacrylate, 3-pentyl cyanoacrylate, 2=phenylethyl cyanoacrylate, methyl methacrylate, methacrylic acid, ethyl methacrylate, hydroxypropyl acrylate, hydroxypropyl methacrylate, iso-butyl methacrylate, n-butyl methacrylate, t-butyl methacrylate, hydroxyethyl methacrylate, behenyl methacrylate, behenyl polyethylenglycol methacylate, cyclohexyl methacrylate, iso-decyl methacrylate, 2-ethylhexyl methacrylate, lauryl methacrylate, methyl polyethyleneglykol methacrylate, stearyl methacrylate, stearyl polyethylenglycol methacrylate, iso-tridecyl methacrylate, ureido methacylate, phenyl methacrylate, etc.) or other additives can be included. Typically, the monomers are included in at most a 30% (e.g., by weight, by volume, by stoichiometry, etc.) relative to the oligomer. However, the concentration can be greater than 30%.

The optional inhibitor can function to control the polymerization (e.g., rate of polymerization, timing of polymerization, extent of crosslinking, etc.). For example, the inhibitor can hinder polymerization from occurring before the polymer electrolyte precursor is added to the battery. Examples of inhibitors include 4-methoxyphenol (MEHQ), monobenzone, hydroquinone, guaiacol, 2-hydroxy-5-methoxybenzaldehyde, 1,2-benzoquinone, 1,4-benzoquinone, 1,4-naphthoquinone, 9,10-anthraquinone, chloranil, quinone methide, p-phenylenediamines, phenothiazine, diethylhydroxylamine, hydroxylhydroxylamine, (2,2,6,6-Tetramethylpiperidin-1-yl)oxyl (TEMPO), 4-hydroxy-TEMPO (TEMPOL), and/or any suitable inhibitor(s) can be used. The concentration of inhibitor is typically less than about 1% (e.g., wt % such as 1 ppb, 10 ppb, 100 ppb, 1 ppm, 10 ppm, 100 ppm, 1000 ppm, values or ranges therebetween) relative to a monomer, oligomer, and/or combined amount of oligomer and monomer. However, the concentration of inhibitor can be greater than 1%.

The initiator can function to start and/or control the polymerization (e.g., rate of polymerization, timing of polymerization, extent of crosslinking, etc.). For example, the initiator can facilitate or start polymerization after the polymer electrolyte precursor is added to the battery (and/or after a treatment begins such as heating the precursor to a threshold temperature, generating radicals using the initiator, illuminating the initiator, electrochemically forming radicals, etc.). Degradation products resulting from decomposition (e.g., thermal decomposition) of the initiator to generate radicals are preferably substantially inert to electrochemical reaction (e.g., within voltage window of the battery, in the electrolyte, etc.). For example, nitrogen can be formed during the radical formation using the initiator (where the nitrogen can be evacuated from the cell). The initiator is preferably stable at room temperature (e.g., does not substantially begin forming radicals at room temperature, room temperature half-life greater than about 12 hours, etc.). However, the initiator can be unstable at room temperature (e.g., where manufacturing, transport, etc. is performed at a temperature below room temperature). Examples of initiators include 2,2′-azobisisobutyronitrile (AIBN), 2,2-Bis(tert-butylperoxy)butane, 1,1-bis(tert-butylperoxy)cyclohexane, 2,2′-azobis[2-(2-imidazolin-2-yl)-propane] dihydrochloride, 2,5-bis(tert-butylperoxy)-2,5-dimethylhexane, 2,5-bis(tert-butylperoxy)-2,5-dimethyl-3-hexyne, bis(1-(tertbutylperoxy)-1-methylethyl)benzene, 1,1-bis(tert-butylperoxy)-3,3,5-trimethylcyclohexane, tert-butyl peracetate, tert-butyl hydroperoxide (TBHP), cumene hydroperoxide, di-tert-butyl peroxide, tert-butyl peroxybenzoate, tert-butylperoxyisopropyl carbonate, dicumyl peroxide, benzoyl peroxide, lauroyl peroxide, 2,4-pentanedione peroxide, peracetic acid, tert-amyl peroxybenzoate, 4,4-azobis(4-cyanovaleric acid), 1,1′-azobis(cyclohexanecarbonitrile) (ABCN or ACHN), ammonium persulfate, potassium persulfate (or other persulfate salts), and/or any suitable initiator can be used. The concentration of initiator is typically between about 0.1% about 10% (e.g., wt % such as 0.1%, 0.2%, 0.3%, 0.5%, 1%, 2%, 2.5%, 3%, 5%, 7%, 7.5%, 9%, 10%, values or ranges therebetween, etc.) relative to a monomer, oligomer, and/or combined amount of oligomer and monomer. However, the concentration of initiator can be less than 0.1% or greater than 10%.

In some specific examples, the electrolyte can include a gel polymer electrolyte as described in U.S. patent application Ser. No. 18/443,695 titled ‘GEL ELECTROLYTE COMPOSITION AND A METHOD OF IMPLEMENTATION’ filed 16 Feb. 2024 which is incorporated in its entirety by this reference. In related examples, the electrolyte can be cured in a manner as described in U.S. patent application Ser. No. 18/443,716 titled ‘GEL ELECTROLYTE COMPOSITION AND A METHOD OF IMPLEMENTATION’ filed 16 Feb. 2024 which is incorporated in its entirety by this reference. However, other suitable electrolytes can be used (inclusive of liquid electrolytes that exclude any polymeric or gel component) and/or other suitable curing techniques can be applied.

In some embodiments of the battery, one or more components of the battery are preferably designed with a mechanically resilient shape. In these embodiments, typically all of the components will have the mechanically resilient shape (i.e., the current collectors, electrodes, and separator are all shaped). However, a subset of components may not have the mechanically resilient shape. Examples of mechanically resilient shapes included: zig-zag, sinusoidal, waffle pattern, herringbone pattern, chevron pattern, diamond pattern (e.g., tread plate pattern), yoshimura pattern, dimple pattern (e.g., repeating hemispheres such as raised hemispheres, raised and depressed hemispheres, depressed hemispheres, etc.), plane space groups (e.g., with alternating raised and lowered regions such as parallelogram lattices, rectangular lattices, centered lattices, square lattices, trigonal lattices, hexagonal lattices, etc.), and/or other similar patterns (e.g., including repetitions of peaks and/or valleys preferably with rounded turning points). Rounded turning point (rather than sharp changes in direction) are preferable as they are less likely than sharp points to act as sites for electrode breaking. A radius of curvature is preferably less than about 10 mm (e.g., 0.1 mm, 0.5 mm, 1 mm, 2 mm, 3 mm, 5 mm, 7 mm, values or ranges therebetween, etc.). However, the radius of curvature can be greater than about 10 mm (e.g., depending on the geometry of the cell). In some variants, the radius of curvature can be different in different directions (e.g., infinite in one axis and finite in another axis, two distinct values in different axes to form an elliptical surface, continuously varying at different points, etc.).

For instance, the battery can be corrugated (as shown for example in FIG. 6A or FIG. 6B), have a waffle pattern (as shown for example in FIG. 6C), and/or can have other suitable patterns or shapes.

The resilient shape can cover the full extent (except for a portion of the battery to enable the casing to be sealed) and/or a subset of the battery (e.g., a portion of the battery most likely to experience mechanical stress such as a central portion, an edge portion, etc.). For instance, between 20 and 80% of the battery can have the resilient shape (where the remainder has a flattened shape).

The specific geometry of the mechanically resilient shape can depend on the battery size (e.g., total battery capacity, battery length, battery width, battery thickness, etc.), a battery material (e.g., anode material, cathode material, separator material, etc.), stress or strain (e.g., flexion) amplitude (e.g., anticipated to be exerted on) the battery, stress or strain frequency (e.g., flexion frequency), battery operating parameters (e.g., depth of discharge during cycling, charging rate, etc.), a directionality of the stress or strain, a location along the battery of the stress or strain, and/or can depend on other suitable properties. In a specific example, the peak-to-valley depth can be between about 0.5 mm and about 10 mm (e.g., 1 mm, 1.5 mm, 2 mm, 3 mm, 4 mm, 5 mm, 7.5 mm, values or ranges therebetween, etc.). In a specific example, the peak-to-peak (or valley-to-valley) distance can be between about 1 mm and 10 cm (e.g., 1.5 mm, 2 mm, 3 mm, 5 mm, 7 mm, 8 mm, 10 mm, 10.5 mm, 11 mm, 12 mm, 15 mm, 20 mm, 22 mm, 25 mm, 30 mm, 33 mm, 45 mm, 50 mm, 66 mm, 75 mm, 80 mm, etc.). In a specific example, a number of repetitions of peaks and valleys can be between 2 and 100 repetitions. In some variations, the geometric pattern can be one-dimensional (as shown for example in FIG. 6A or FIG. 6B). In these variations, the peaks and troughs can be parallel to a length of the battery cell, parallel to a width of the battery cell, and/or can be arranged at an intermediate angle therebetween. In other variations, the geometric pattern can be 2-dimensional (as shown for example in FIG. 6C), where the pattern can have the same or different geometric properties in each direction (e.g., the same or different periodicity, the same or different amplitude, etc.). In these variations, the pattern preferably has different periodicity in orthogonal directions (e.g., peak-to-peak or valley-to-valley separations) such as a first periodicity propagating along a long axis of the battery and a second periodicity propagating along a short axis of the battery. Typically, the first periodicity is smaller than the second periodicity. However, the second periodicity can be smaller than the first periodicity and/or the first and second periodicity can be the same.

The resilient shape is preferably formed in the battery prior to and/or concurrently with curing the electrolyte (as the resulting cured electrolyte can retain the resilient shape of the battery). However, the resilient shape can be formed after curing the electrolyte and/or without curing the electrolyte. The resilient shape can be formed, for instance, by rolling, pressing, stamping, 3D printing, coining, casting, drawing, hydroforming, sinking, and/or using other suitable forming process(s).

### Illustrative Examples

In a first illustrative example, a flexible battery can comprise: a cathode current collector comprising a cathode current collector tab and a cathode substrate; a cathode disposed on the cathode substrate; a separator a separator wherein a first broad face of the separator is directed toward a broad face of the cathode opposing the cathode substrate; an anode directed toward a second broad face of the separator opposing the first broad face of the separator; an anode current collector comprising an anode current collector tab and an anode substrate, wherein the anode is disposed on the anode substrate; a first tab welded to the cathode current collector tab; a second tab welded to the anode current collector tab; an electrolyte interspersed within the cathode, the separator, and the anode; and a casing enclosing the cathode current collector, the cathode, the separator, the anode, and the anode current collector, wherein the casing is hermetically sealed using an adhesive, wherein the adhesive is disposed on the weld between the first tab and the cathode current collector and on the weld between the second tab and the anode current collector. In some variations, the flexible battery can include a plurality of cathodes and a plurality of anodes, where each cathode is in electrochemical communication with an anode of the plurality of anodes across a separator (where a plurality of separators can be used), where the cathode current collector is in electrical contact with each cathode of the plurality of cathode and the anode current collector is in electrical contact with each anode of the plurality of anodes.

In a second illustrative example, a flexible battery can comprise a cathode current collector comprising a cathode current collector tab and a cathode substrate, wherein the cathode current collector tab comprises a plurality of folds; a cathode disposed on the cathode substrate; a separator wherein a first broad face of the separator is directed toward a broad face of the cathode opposing the cathode substrate; an anode directed toward a second broad face of the separator opposing the first broad face of the separator; an anode current collector comprising an anode current collector tab and an anode substrate, wherein the anode is disposed on the anode substrate, wherein the anode current collector tab comprises a plurality of folds; a first tab welded to the cathode current collector tab; a second tab welded to the anode current collector tab; an electrolyte interspersed within the cathode, the separator, and the anode; and a casing enclosing the cathode current collector, the cathode, the separator, the anode, and the anode current collector. In some variations, the flexible battery can include a plurality of cathodes and a plurality of anodes, where each cathode is in electrochemical communication with an anode of the plurality of anodes across a separator (where a plurality of separators can be used), where the cathode current collector is in electrical contact with each cathode of the plurality of cathode and the anode current collector is in electrical contact with each anode of the plurality of anodes.

In a third illustrative example a flexible battery can comprise a cathode current collector comprising a cathode current collector tab and a cathode substrate; a cathode disposed on the cathode substrate; a separator wherein a first broad face of the separator is directed toward a broad face of the cathode opposing the cathode substrate; an anode directed toward a second broad face of the separator opposing the first broad face of the separator; an anode current collector comprising an anode current collector tab and an anode substrate, wherein the anode is disposed on the anode substrate; a first tab welded to the cathode current collector tab; a second tab welded to the anode current collector tab; an electrolyte interspersed within the cathode, the separator, and the anode; and a casing enclosing the cathode current collector, the cathode, the separator, the anode, and the anode current collector; wherein the casing, the cathode current collector, the cathode, the separator, the anode, and the anode current collect comprise a mechanically resilient shape comprising a first periodically repeating element along a first direction and a second periodically repeating element along a second direction orthogonal to the first direction, wherein a periodicity of the first periodically repeating element is different from a periodicity of the second periodically repeating element. In some variations, the flexible battery can include a plurality of cathodes and a plurality of anodes, where each cathode is in electrochemical communication with an anode of the plurality of anodes across a separator (where a plurality of separators can be used), where the cathode current collector is in electrical contact with each cathode of the plurality of cathode and the anode current collector is in electrical contact with each anode of the plurality of anodes.

In a fourth illustrative example, the flexible battery of the first or the second illustrative example or the mechanically resilient shape of the third illustrative example, wherein the casing and its contents comprise a corrugated pattern, waffle pattern, Yoshimura pattern, or dimple pattern (e.g., 2D grid of dimples on a square, parallelogram, hexagonal, trigonal, etc. lattice).

In a fifth illustrative example, the flexible battery of the second or third illustrative example, wherein the casing is hermetically sealed using an adhesive, wherein the adhesive is disposed on the weld between the first tab and the cathode current collector and on the weld between the second tab and the anode current collector.

In a sixth illustrative example, the flexible battery of the first or fifth illustrative example, wherein the welds are disposed between two layers of adhesive.

In a seventh illustrative example, the flexible battery of the first or the third illustrative example, wherein the cathode current collector tab and the anode current collector tab each comprise a plurality of folds to increase mechanical resilience of the cathode current collector tab and the anode current collector tab.

In an eight illustrative example, the flexible battery of any of the first, second, fifth, or seventh illustrative examples wherein the plurality of folds of the cathode current collector are disposed between the weld and the cathode and wherein the plurality of folds of the anode current collector are disposed between the weld and the anode.

In a ninth illustrative example, the flexible battery of any of the first, second, third, fourth, fifth, sixth, seventh, eighth, or ninth illustrative examples, wherein the electrolyte comprises a gel polymer electrolyte formed by polymerizing a polymer precursor and a plasticizer.

In a tenth illustrative example, the flexible battery of the ninth illustrative example, wherein: the polymer precursor comprises at least one of: polyester urethane acrylates, polyester urethane methacrylates, polyether urethane acrylates, polycarbonate urethane acrylates, polycarbonate-polyether urethane acrylates, polycarbonate-polyester urethane acrylates, polyether-polyester urethane acrylates, polyimide urethane acrylates, polycarbonate urethane methacrylates, polycarbonate-polyether urethane methacrylates, polycarbonate-polyester urethane methacrylates, polyether-polyester urethane methacrylates, polyimide urethane methacrylates, polybutadiene urethane acrylates, polybutadiene urethane methacrylates, bisphenol A epoxy diacrylate, silicone urethane acrylate, thioether dendritic acrylates, thioether dendritic methacrylates, functional aliphatic polyether urethane acrylate, difunctional aromatic urethane acrylate, or difunctional aliphatic hydrophobic urethane acrylate; and the plasticizer comprises: a polar aprotic solvent comprising at least one of ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, lactic acid O-carboxyanhydride, tetrahydroxy-1,4-benzoquinone biscarbonate, di-tert-butyl carbonate, di-tert-butyl decarbonate, diethyl carbonate, diethyl pyrocarbonate, dimethyl carbonate, ethyl methyl carbonate, diallyl carbonate, diphenyl carbonate, methyl(2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethyl orthoformate, 2,2-diethoxytetrahydrofuran, methyl formate, ethyl formate, methyl propionate, methyl butanoate, ethyl formate, ethyl acetate, ethyl propionate, propyl formate, propyl acetate, or propyl propionate; and a salt comprising at least one of lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium difluorooxalatoborate, lithium bis(fluorosulfonyl)imide, lithium bis(trifluoromethanesulfonyl)imide, lithium-cyclo-difluoromethane-1,1-bis(sulfonyl)imide, lithium fluoromalonato(difluoro)borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl)sulfonyl]methane, lithium nitrate, or lithium 2,2-difluoro-4,5-dioxo-1,3,2-dioxaborolane-2-uide.

In an eleventh illustrative example, the flexible battery of the third or fourth, seventh, ninth, or tenth illustrative example, wherein the mechanically resilient shape is maintained by the electrolyte.

In an eleventh illustrative example, the flexible battery of the third or fourth, seventh, ninth, tenth, or eleventh illustrative example, wherein the mechanically resilient shape comprises rounded edges between changes in direction.

In a twelfth illustrative example, a flexible battery can include one, two, or three of a mechanically resilient shape, buried welds, and/or mechanically resilient current collector tabs.

In a thirteenth illustrative example, a method for manufacturing a flexible battery of any of the first through twelfth illustrative examples.

In a fourteenth illustrative example, the thirteenth illustrative example wherein a polymer electrolyte precursor (such as that of the tenth illustrative example) is thermally cured to form a gel polymer electrolyte.

In a fifteenth illustrative example, the method of the thirteenth or fourteenth illustrative example where the mechanically resilient shape is rolled, cut, or stamped into the flexible battery.

In a sixteenth illustrative example, the flexible battery of any of the second, seventh, eighth, ninth, tenth, or eleventh illustrative examples, wherein the cathode current collector tab and the anode current collector tab each comprises a stretched length (e.g., total length) between 1.5 and 4 cm.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the preceding system and/or method can be used with, in addition to, in lieu of, or otherwise integrated with all or a portion of the systems and/or methods disclosed in the applications mentioned above, each of which are incorporated in their entirety by this reference.

As used herein, “substantially” or other words of approximation (e.g., “about,” “approximately,” etc.) can be within a predetermined error threshold or tolerance of a metric, component, or other reference (e.g., within 0.001%, 0.01%, 0.1%, 1%, 5%, 10%, 20%, 30% of a reference), or be otherwise interpreted.

As a person skilled in the art will recognize from the previous detailed description and from the figures and claims, modifications and changes can be made to the preferred embodiments of the invention without departing from the scope of this invention defined in the following claims.

We claim:

1. A method comprising:
conferring a mechanically resilient shape to a cathode current collector tab and an anode current collector tab;
welding the cathode current collector tab to a cathode current collector and the anode current collector tab to an anode current collector, wherein the cathode current collector is coated with a cathode active material and the anode current collector is coated with an anode active material;
wetting the anode and the cathode with a gel electrolyte precursor solution comprising:
a polymer precursor comprising dynamic bonding moieties and ion conductive moieties;
an initiator; and
a plasticizer;
sealing a case surrounding the cathode current collector, the cathode, the anode, the anode current collector, and the gel electrolyte precursor solution; and
curing the gel electrolyte precursor solution to form a covalently bonded gel electrolyte network.

2. The method of claim 1, wherein curing the gel electrolyte precursor solution results in the covalently bonded gel electrolyte network interspersed throughout the cathode, the anode, and a separator disposed between the anode and the cathode.

3. The method of claim 1, wherein the covalently bonded gel electrolyte network comprises an ionic conductive of at least 0.1 mS/cm at 25° C.

4. The method of claim 1, wherein the plasticizer comprises:
a polar aprotic solvent comprising at least one of ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, lactic acid O-carboxyanhydride, tetrahydroxy-1,4-benzoquinone biscarbonate, di-tert-butyl carbonate, di-tert-butyl decarbonate, diethyl carbonate, diethyl pyrocarbonate, dimethyl carbonate, ethyl methyl carbonate, diallyl carbonate, diphenyl carbonate, methyl(2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethyl orthoformate, 2,2-diethoxytetrahydrofuran, methyl formate, ethyl formate, methyl propionate, methyl butanoate, ethyl formate, ethyl acetate, ethyl propionate, propyl formate, propyl acetate, or propyl propionate; and
a salt comprising at least one of lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium difluorooxalatoborate, lithium bis(fluorosulfonyl)imide, lithium bis(trifluoromethanesulfonyl)imide, lithium-cyclo-difluoromethane-1,1-bis(sulfonyl)imide, lithium fluoromalonato(difluoro)borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl)sulfonyl]methane, lithium nitrate, or lithium 2,2-difluoro-4,5-dioxo-1,3,2-dioxaborolane-2-uide.

5. The method of claim 4, wherein the plasticizer further comprises an additive comprising at least one of fluoroethylene carbonate, vinylene carbonate, methylene ethylene carbonate, 3-fluoro-1,3-propanesultone, prop-1-ene-1,3-sultone, trimethyl phosphate, triethyl phosphate, tributyl phosphate, triphenyl phosphate, tris(2,2,2-trifluorethyl)phosphate, bis(2,2,2-trifluoroethyl)methyl phosphate, trimethylphosphite, triethyl phosphite, tributyl phosphite, tris(2,2,2-trifluorethyl)phosphite, dimethyl methylphosphonate, diethyl ethylphosphonate, bis(2,2,2-trifluoroethyl) methylphosphonate, bis(2,2,2-trifluoroethyl)ethylphosphonate, hexamethoxycyclotriphosphazene, N-methyl-2-pyrrolidone, ethoxy(pentafluoro)cyclotriphosphazene, pentafluoro(phenoxy cyclotriphosphazene, tris(trimethylsilyl)phosphite, tris(trimethylsilyl)phosphate, or diethyl phenylphosphonite.

6. The method of claim 1, wherein curing the gel electrolyte precursor comprises thermally curing the gel electrolyte precursor by maintaining a temperature of the gel electrolyte precursor and the battery stack between 60 and 80° C. for between 0.5 and 24 hours.

7. The method of claim 1, wherein the dynamic bonding moieties are capable of dynamic bonding via hydrogen bonding or ion pairing interactions.

8. The method of claim 1, wherein sealing the case comprises applying a polymeric sealant to the case, wherein the polymeric sealant completely covers a weld region between the cathode current collector tab and the cathode current collector and wherein the polymeric sealant completely covers a weld region between the anode current collector tab and the anode current collector.

9. The method of claim 1, wherein sealing the case comprises applying a polymeric sealant to the case, wherein the polymeric sealant extends at most 2 mm into the case from any direction, wherein the polymeric sealant extends outside the case.

10. The method of claim 1, further comprising patterning the casing, the cathode current collector, the cathode, the anode current collector, and the anode with a nonplanar pattern prior to curing the gel electrolyte precursor solution.

11. The method of claim 10, wherein the nonplanar pattern comprises a corrugated morphology.

12. The method of claim 1, wherein the mechanically resilient shape comprises a corrugated morphology.

13. The method of claim 1, wherein the cathode current collector tab and the anode current collector tab comprise a woven metal fabric.

14. A flexible battery comprising:
a cathode comprising:
a cathode current collector with a cathode active material disposed thereon; and
a cathode current collector tab welded to the cathode current collector, wherein the cathode current collector tab comprises a mechanically resilient shape;
an anode comprising:
an anode current collector with an anode active material disposed thereon; and
an anode current collector tab welded to the anode current collector, wherein the anode current collector tab comprises a mechanically resilient shape;
a separator disposed between the cathode and the anode;
a unified gel electrolyte dispersed throughout the cathode, the anode, and the separator; and
a casing enclosing the cathode current collector, the cathode, the separator, the anode, and the anode current collector, wherein the casing is hermetically sealed using an adhesive, wherein the adhesive completely covers a weld between the cathode current collector and the cathode current collector tab and a weld between the anode current collector and the anode current collector tab, wherein the casing, the cathode current collector, the cathode, the separator, the anode, the anode current collector, and the unified gel electrolyte comprise nonplanar geometry.

15. The flexible battery of claim 14, wherein the mechanically resilient shape of the cathode current collector tab and the anode current collector tab each comprise a plurality of folds.

16. The flexible battery of claim 14, wherein the mechanically resilient shape in the cathode current collector tab is disposed between the cathode and the weld between the cathode current collector and the cathode current collector tab and wherein the mechanically resilient shape in the anode current collector tab is disposed between the anode and the weld between the anode current collector and the anode current collector tab.

17. The flexible battery of claim 14, wherein the nonplanar pattern comprises a Yoshimura pattern.

18. The flexible battery of claim 14, wherein the unified gel electrolyte comprises:
a cross-linked structure with a plurality of hydrocarbon backbones consisting of carbon-carbon bonds and a second backbone, interlinking two of the plurality of hydrocarbon backbones, wherein the second backbone comprises hydrogen bond accepting groups within the second backbone; and
a plasticizer comprising:
a solvent selected from the group consisting of: ethylene carbonate, fluoroethylene carbonate, propylene carbonate, vinylene carbonate, trimethylene carbonate, 1,2-butylene carbonate, 2,3-butylene carbonate, trifluoropropylene carbonate, methylene ethylene carbonate, dioxazolone, hexahydroxybenzene triscarbonate, ethylenetetracarboxylic dianhydride, lactic acid O-carboxyanhydride, tetrahydroxy-1,4-benzoquinone biscarbonate, di-tert-butyl carbonate, di-tert-butyl decarbonate, diethyl carbonate, diethyl pyrocarbonate, dimethyl carbonate, ethyl methyl carbonate, diallyl carbonate, diphenyl carbonate, methyl(2,2,2-trifluoroethyl) carbonate, bis(2,2,2-trifluoroethyl) carbonate, dimethoxyethane, diethyl ether, tetrahydrofuran (oxolane), tetraethoxymethane, tetramethoxymethane, triethyl orthoacetate, triethyl orthoformate, trimethyl orthoformate, 2,2-diethoxytetrahydrofuran, methyl formate, ethyl formate, methyl propionate, methyl butanoate, ethyl formate, ethyl acetate, ethyl propionate, propyl formate, propyl acetate, propyl propionate, or combinations thereof;
a salt selected from the group consisting of: lithium hexafluorophosphate, lithium hexafluoroarsenate, lithium tetrafluoroborate, lithium chlorate, lithium 2,3,7,8-tetraoxo-1,4,6,9-tetraoxa-5-boraspiro[4.4]nonan-5-uide, lithium difluorophosphate, lithium difluorooxalatoborate, lithium bis(fluorosulfonyl)imide, lithium bis(trifluoromethanesulfonyl)imide, lithium-cyclo-difluoromethane-1,1-bis(sulfonyl)imide, lithium fluoromalonato(difluoro)borate, lithium trifluoromethanesulfonate, lithium tetraoxo-1,4,6,9-tetraoxa-5-boraspiro[4,4]nonan-5-uide, lithium trifluoro[(trifluoromethansulfonylazanidyl)sulfonyl]methane, lithium nitrate, lithium 2,2-difluoro-4,5-dioxo-1,3,2-dioxaborolane-2-uide, and combinations thereof; and
an additive selected from the group consisting of: fluoroethylene carbonate, vinylene carbonate, methylene ethylene carbonate, 3-fluoro-1,3-propanesultone, prop-1-ene-1,3-sultone, trimethyl phosphate, triethyl phosphate, tributyl phosphate, triphenyl phosphate, tris(2,2,2-trifluorethyl)phosphate, bis(2,2,2-trifluoroethyl)methyl phosphate, trimethylphosphite, triethyl phosphite, tributyl phosphite, tris(2,2,2-trifluorethyl)phosphite, dimethyl methylphosphonate, diethyl ethylphosphonate, bis(2,2,2-trifluoroethyl)methylphosphonate, bis(2,2,2-trifluoroethyl)ethylphosphonate, hexamethoxycyclotriphosphazene, N-methyl-2-pyrrolidone, ethoxy(pentafluoro)cyclotriphosphazene, pentafluoro(phenoxy)cyclotriphosphazene, tris(trimethylsilyl)phosphite, tris(trimethylsilyl)phosphate, diethyl phenylphosphonite, and combinations thereof.

19. The flexible battery of claim 18, wherein the second backbone further comprises moieties capable of dynamic bonding via hydrogen bonding or ion pairing interactions.

20. The flexible battery of claim 18, wherein a hydrocarbon backbone of the plurality of hydrocarbon backbones further comprises pendant groups capable of toughening the unified gel electrolyte.

21. The flexible battery of claim 14, wherein the cathode current collector tab and the anode current collector tab comprise conductive woven fabrics.
